(19) United States
(12) Patent Application Publication
(10) Pub. No.: US 2015/0053771 A1
(43) Pub. Date: Feb. 26, 2015

(54) Deformable smart business card for direct interface to computer or laptop USB ports

(71) Applicant: Eric M. Juetten, Brooklyn Park, MN (US)

(72) Inventor: Eric M. Juetten, Brooklyn Park, MN (US)

(21) Appl. No.: 14/121,338

(22) Filed: Aug. 21, 2014

Related U.S. Application Data
(60) Provisional application No. 61/959,390, filed on Aug. 22, 2013.

(51) Int. Cl. G06K 19/077

(52) U.S. Cl. CPC G06K 19/07743; G06K 19/07732
USPC 235/492

(57) ABSTRACT

One embodiment of the invention describes a deformable smart business card comprising a thin substrate in the shape and form of a business card amenable to folding along predetermined fold lines, the thin substrate with embedded integrated electronic components and electrical contacts, the electrical contacts in electrical communication with integrated electronic components and routed to one edge of the thin substrate, and termination of the electrical contacts compatible with insertion into computer USB ports when the smart business card is folded along said predetermined fold lines.

### CROSS REFERENCE TO RELATED APPLICATIONS

This application claims the benefit of U.S. Provisional Patent Application No. 61/959,390 filed Aug. 22, 2013, which hereby is incorporated herein in its entirety by reference thereto.

### FIELD OF THE INVENTION

The present invention is directed generally to smart business cards, and more particularly to a smart business card which can be easily mechanically deformed such that electrical contacts incorporated in the card may be directly inserted into standard computer USB ports.

### BACKGROUND

Smart cards have been used in electronic commerce for some time. Simple smart cards incorporate a memory device whereas more advanced smart cards supplement the memory with a processing capability. Smart cards are capable of providing secure encryption of sensitive data and of providing authentication of electronic transactions.

Smart card technology has made impressive advances in the past few years. The cost of manufacturing smart cards has seen dramatic decreases. Smart cards come generally in two flavors: a processor-based smart card and a low-cost memory smart card. The form factors of these smart cards are the size of business cards. One of the financial applications of the higher cost processor-based smart cards is the intelligent business card. Business card manufacturers have embedded the smart card technology into a business card without changing the dimensions of the standard business card.

There are numerous examples of smart card technology in the prior art, all of which require a separate “card reader” device. For example, U.S. Pat. No. 5,493,105 by Desai (the “105 patent”) discloses an electronic business card system with a business card having computer readable data stored on computer readable storage media. The '105 patent further discloses a card reader coupled to a computer control system so that card data can be organized and manipulated. Specifically, the '105 patent discloses “an electronic business card having first and second sides” where the first side has “computer readable storage media” for the storing of business card data, and the second side has “a printed text representation of the business card data for visual representation.” In one embodiment of the '105 patent, “organizational parameters are selected from a group consisting of: a name, a business name, a specialty, an address, a telephone number, an area code, and a zip code.” The '105 patent further discloses a magnetic strip card reader and states that other types of card readers are also envisioned such as optical, memory cards, and others.

Similarly, U.S. Pat. No. 7,322,513 by Kuo, et al. discloses a multimedia intelligent business card system which allows multimedia and Web content to be stored on a smart card. The invention automatically and selectively translates each file, URL, or file references as they should be when the contents of the smart card are read. The invention waits for the smart card to be inserted into a smart card reader attached to or resident in the host computer and intelligently distinguishes between a multimedia, Web-enabled, or combination smart card. A multimedia file/mp3 file/playlist or URL address is accessed from the smart card. The multimedia player required to play the accessed file/playlist or the browser required to display the accessed URL is determined and the accessed file/playlist is sent to the multimedia player and played to the user or the accessed URLA is sent to the browser and the Website is displayed to the user. The invention enables multiple auto play from multimedia files/MP3 playlist and multiple automatic connections with multiple URLs. A hotkey is defined on the host computer. If the user presses the hotkey during playback, the invention will access the smart card for the next mp3 file in the playlist, or URL, if it exists.

U.S. Pat. No. 6,910,627 to Simpson-Young, et al. discloses an electronic ticketing system and method utilizing a smart card. The smart card can be loaded with pre-purchased tickets which are then booked at a subsequent date. Alternatively, the booking and payment for the ticket can be made at the one transaction. The smart card is customizable by a user who would normally be a promoter or organizer of an event for which tickets are required. Also disclosed is a multiple purpose card which is both a smart card having electronic data stored therein and a conventional business card having information printed thereon for use by a reader. The recipient of the card is able to insert same into a card reader to obtain detailed information from the computer of the donor of the card. The multiple purpose smart card may also be used as a trading card as part of a set of similar cards each offering differing levels of user access to a database related to the set.

The prior art has numerous other such examples of smart card type devices all of which have the cumbersome necessity of requiring a separate and distinct card reader to access the information enclosed on the card. In today's fast paced business travel, the preferred piece of mobile hardware is the cell phone and the laptop computer. In this environment, it would be highly desirable if smart cards could be directly interfaced with the USB port on the laptop (or desktop) computer.

### SUMMARY OF THE INVENTION

Generally, the present invention is directed to smart business cards, and more particularly to a smart business card which can be easily mechanically deformed such that electrical contacts incorporated in the card may be directly inserted into standard computer USB ports.

One embodiment of the invention describes a deformable smart business card comprising a thin substrate in the shape and form of a business card amenable to folding along predetermined fold lines, the thin substrate with embedded integrated electronic components and electrical contacts, the electrical contacts in electrical communication with integrated electronic components and routed to one edge of the thin substrate, and termination of the electrical contacts compatible with insertion into computer USB ports when the smart business card is folded along said predetermined fold lines.

The above summary of the present invention is not intended to describe each illustrated embodiment or every implementation of the present invention. The figures and the detailed description which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1A shows a schematic representation of one embodiment of the present invention depicting the top surface of the deformable smart business card highlighting the fold lines.

FIG. 1B shows a breakout of the components embedded within the deformable smart card highlighting the buried electrical leads and integrated electronics.

FIG. 2A shows the smart business card depicted in FIGS. 1A and 1B shown after folding along the dotted lines.

FIG. 2B shows the smart business card depicted in FIG. 2A inserted into the USB port of a computer.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is directed generally to smart business cards, and more particularly to a smart business card which can be easily mechanically deformed such that electrical contacts incorporated in the card may be directly inserted into standard computer USB ports.

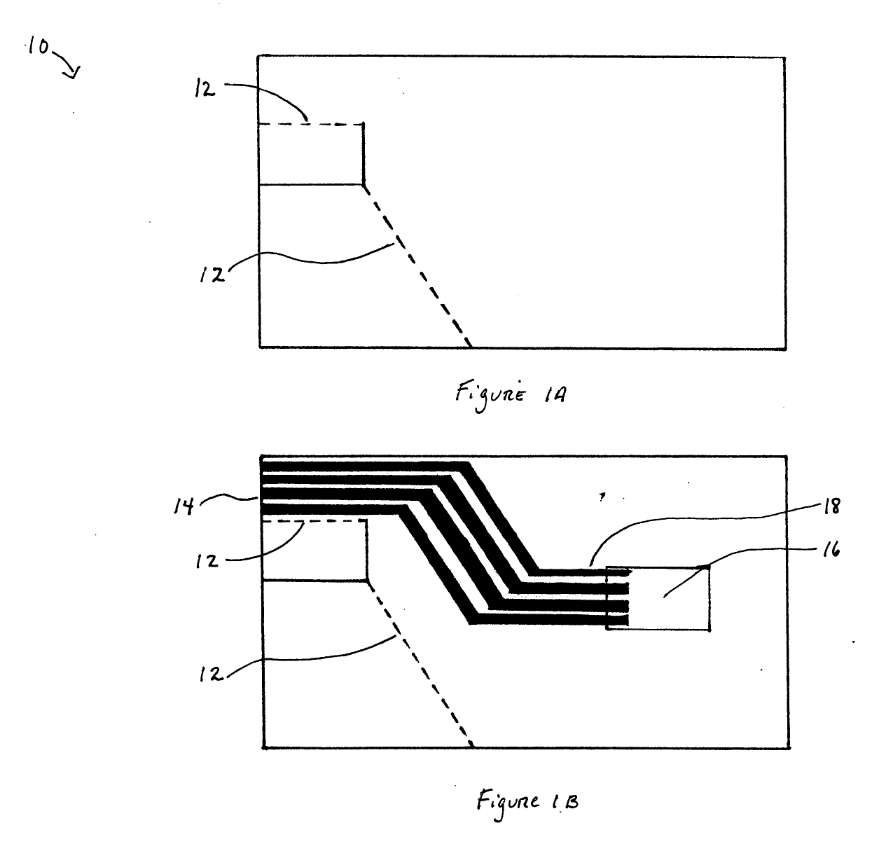

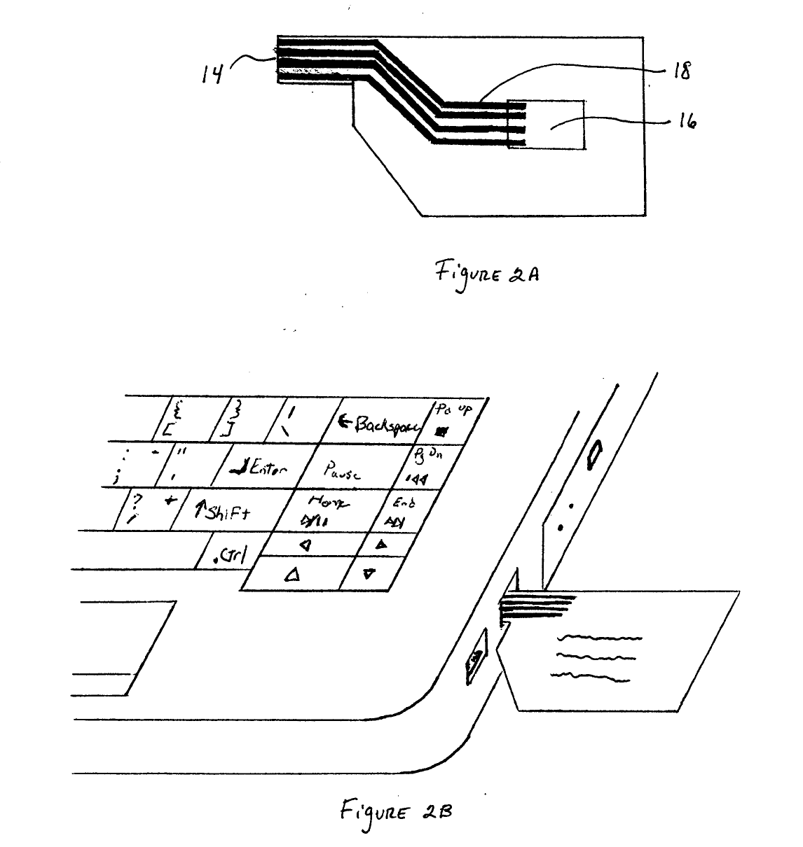

One embodiment of a deformable smart card 10 in accordance with the present invention is shown schematically in FIGS. 1A and 1B. The dotted lines 12 in FIGS. 1A and 1B denote regions of the deformable smart card 10 which can be folded so as to expose the outermost region 14 of electrical contacts 18. As shown in FIG. 2A, the physical spacing and dimensions of the exposed electrical contacts 14 may be consistent with the standard dimensions to be inserted directly into laptop or desktop computer USB ports (as shown in FIG. 2B).

FIG. 1A shows the top surface of the deformable smart card 10 which may be a smooth surface as is commonly found on ordinary paper business cards and may have the standard contact information of the card holder such as name, address, phone number, etc., printed thereon (not shown in FIG. 1A).

FIG. 1B shows one potential layout of the electrical contacts 18 shown in electrical communication with embedded integrated circuitry 16. Both the electrical contacts 18 and the integrated circuitry 16 may be embedded within the deformable smart card 10 and not visible from the outside. The embedded integrated circuitry 16 may comprise a read-write memory device or other such electronic component to allow storage and retrieval of card holder information. In this embodiment of the present invention, the deformable smart card 10 may serve as both a business card for the card holder and a portable flash drive to update or augment current data stored in the integrated circuitry 16.

In an alternative embodiment of the present invention, the integrated circuitry 16 may be comprised of write protected/read only memory devices allowing the card holder an assurance of the integrity in the stored data.

The deformable nature of the smart card 10 may be designed to be either permanent or reversible. In one embodiment of the invention, the dotted lines 12 may represent fold lines which permanently expose the outermost region 14 of electrical contacts 18 and leave the smart card 10 as depicted in FIG. 2A. Alternatively, the dotted lines 12 in FIG. 1A may represent regions in the smart card 10 wherein the thickness of the smart card 10 has been intentionally thinned during manufacture so as to make the smart card flexible and foldable along the said dotted lines. Ideally, in this embodiment the smart business card 10 may be folded and unfolded multiple times and returned to its original shape as depicted in FIG. 1A without loss of mechanical integrity, i.e., no memory effect from folding.

Concerning geometry and chemical composition, the smart card 10 may be roughly 3 inches by 2 inches, which is consistent with standard business cards in use today. The thickness may be slightly larger to accommodate embedded electronics. The chemical composition of the smart card 10 may be comprised primarily of polyvinyl chloride acetate (commonly referred to as PVCA) combined with plasticizers that ultimately yields a water proof surface; however, other hydrophobic or hydrophilic compositions could be employed.

In an alternative embodiment of the present invention, the integrated electronics 16 depicted in FIG. 1B may be mounted on the surface of the smart card 10 instead of embedded therein. In this configuration, it may be beneficial to use surface mount technology (SMT) for the integrated circuitry 16 to eliminate the need for through hole connections. In all the embodiments described above, the integrated circuitry 16 may include memory devices that store the personal contact information of the card holder.

The present invention should not be considered limited to the particular examples described above, but rather should be understood to cover all aspects of the invention as fairly set out in the attached claims. Various modifications to the shape and form factors described above, equivalent processes as well as numerous structures to which the present invention may be applicable will be readily apparent to those of skill in the art to which the present invention is directed upon review of the present specification. The following claims are intended to cover such modifications and devices.

I claim:

1. A deformable smart business card comprising:
a thin substrate in the shape and form of a business card amenable to folding along predetermined fold lines;
said thin substrate with embedded integrated electronic components and electrical contacts;
said electrical contacts in electrical communication with integrated electronic components and routed to one edge of the thin substrate; and
termination of said electrical contacts compatible with insertion into computer USB ports when the smart business card is folded along said predetermined fold lines.

2. The device of claim 1 wherein the foldable nature along the predetermined fold lines of the smart business card is reversible.

3. The device of claim 1 wherein the predetermined fold lines are sufficiently thin that folding along the said the predetermined fold lines cleaves the smart business card.

4. The device of claim 1 wherein the region proximate the predetermined fold lines is sufficiently brittle such that folding along said lines cleaves the smart business card.

5. The device of claim 1 wherein the integrated electronic components and the electrical contacts are embedded within the substrate.

6. The device of claim 1 wherein the integrated electronic components are mounted on the surface of the substrate and the electrical contacts are embedded within the substrate.

7. The device of claim 6 wherein the integrated electronic components are mounted on the surface of the substrate and are in electrical communication with the embedded electrical contacts.
